(19) United States
(12) Patent Application Publication
(10) Pub. No.: US 2016/0214342 A1
(43) Pub. Date: Jul. 28, 2016

(54) APPARATUS AND METHOD FOR COMPRESSING PLASTICS MATERIAL CONTAINERS WHILE PREVENTING STRESS WHITENING

(71) Applicant: KRONES AG, Neutraubling (DE)

(72) Inventor: JOCHEN KRUEGER, HAGELSTADT (DE)

(73) Assignee: KRONES AG, NEUTRAUBLING (DE)

(21) Appl. No.: 14/917,289

(22) PCT Filed: Sep. 9, 2014
(86) PCT No.: PCT/EP2014/069164

§ 371 Date: Mar. 8, 2016

(30) Foreign Application Priority Data
Sep. 9, 2013 (DE) 10 2013 109 842.8

(51) Int. Cl. B30B 9/32; B29C 69/02; B29C 49/42; B30B 15/34

(52) U.S. Cl. CPC B30B 9/321; B30B 15/34; B29C 69/025; B29C 49/4273; B29L 2031/7158

(57) ABSTRACT

An apparatus and method is provided for compressing plastics material containers, having a first holding device which is suitable for holding a first region of a container to be emptied, having a second holding device which is suitable for holding and/or supporting a second region of the container to be emptied, having a movement device which is suitable for moving the first holding device towards the second holding device in order to compress the container located between the first holding device and the second holding device, wherein the first holding device has a cross-section which is smaller than a cross-section of the container to be compressed, so that the first region of the container that is held by the first holding device can be introduced into a further section of the container, thereby forming a fold running circumferentially relative to a longitudinal direction of the container.

### CROSS-REFERENCE TO RELATED APPLICATIONS

This application claims priority to PCT Application No. PCT/EP2014/069164, having a filing date of Sep. 9, 2014, based on DE 10 2013 109 842.8, having a filing date of Sep. 9, 2013, the entire contents of which are hereby incorporated by reference.

### FIELD OF TECHNOLOGY

The following relates to an apparatus and a method for compressing plastics material containers. Such apparatuses and methods are known in the beverage production industry. These are usually used to compress filled containers and in this way to press liquid out of said containers. However, the applicant has more recently transitioned to another method. Particularly when producing large containers, the problem arises that very high volumes and/or weights must be transported during transport. The applicant has therefore proposed, the concept of first producing plastics material containers, for example by way of a blow moulding operation, then compressing these in an empty state, palletizing the compressed containers, and transporting these pallets to a bottling plant. The latter can then expand the containers and fill the latter with liquid, wherein also the filling operation itself may re-expand the container.

### BACKGROUND

This compression of the empty containers has proven to be a workable possibility, particularly in the case of plastics material containers. In a method known by the applicant, a mouth region of the container is rolled into a base region of the container by the compression operation. This means that the container is not compressed in a random and uncontrolled manner, but rather one part of the container is rolled inwards. This gives rise to a circumferential folded edge which is likewise rolled inwards during the compression operation.

However, it has proven to be problematic in the method that locations of stress whitening or the like may in some cases occur. These locations lead to instabilities of the compressed container. Furthermore, the containers must also be relaxed again after the compression, that is to say the pressure in the container must be lowered to the atmospheric pressure. In doing so, the fold formed during this rolling operation contracts and may exhibit creases after the venting. Due to the contraction, the fold also greatly tightens on a respective stamp, so that the rolled container can be detached from the stamp only with difficulty.

### SUMMARY

An aspect relates to the removal of the compressed container from the stamp or the holding device, and on the other hand also to reduce the risk of stress whitening occurring and preferably also to improve the stackability of the containers.

An apparatus according to embodiments of the invention for compressing plastics material containers has a first holding device which is suitable for holding a first region of a container to be emptied. The apparatus further has a second holding device which is suitable for holding and/or supporting a second region of the container to be emptied, wherein the second region is at a distance from the first region. The apparatus further has a movement device which is suitable for moving the first holding device towards the second holding device in order to compress the container located between the first holding device and the second holding device. The first holding device has a cross-section which is preferably smaller than a cross-section of the container to be compressed, so that the first holding device with the first region of the container that is held by the first holding device can be introduced into a further section of the container, thereby forming a fold running circumferentially relative to a longitudinal direction of the container.

According to embodiments of the invention, there is provided on the first holding device a stop element which makes contact with the fold in a predefined relative position of the first holding device relative to the second holding device and/or the apparatus has a pressure generating device which applies to an interior of the container to be compressed, at least at times during the compression of the latter, an internal pressure which is greater than the external pressure prevailing around the container. Advantageously, the fold is a rolling fold. Hereinafter, therefore, the term rolling fold will also be used in place of the term fold.

Preferably, the first holding device is configured as a stamp element which, during the compression operation, advantageously bears flat against a wall region of the container to be compressed. This flat bearing prevents the occurrence of kinks and folds during the compression operation. Advantageously, only one such fold should be produced during the compression operation. A mouth region of the container can thus bear flat against the first holding device and the latter can move this entire mouth region of the container into the base region of the container.

Advantageously, the first holding device has a circular cross-section. In addition, the first holding device advantageously also has a receiving space for receiving the actual mouth of the container. The mouth is preferably a region of the container which has not been stretched during an optionally preceding blow moulding operation. This mouth may also have a thread for fitting a closure, particularly an external thread.

During the compression, the region of the container adjoining the mouth can be pivoted and can bear against an outer surface of the first holding device. Preferably, therefore, an outer contour of the first holding device is matched to a contour of the container that is obtained during this compression of the container, in order, as mentioned, to avoid the occurrence of kinks and breaks.

It is possible that a curvature on an outer surface is matched to a curvature of the mouth region of the container.

Two procedures are proposed here, but these both relate to the production and/or processing of said fold. Both possibilities lead to the situation whereby kinks and cracks are prevented at the fold and also the removal of the container from the first holding device is made easier. Advantageously, as mentioned above, the container to be compressed is an empty container.

As mentioned above, during the compression of the container, the fold rolls upwards along the holding device (which can also be referred to as a stamp). In a predefined position of the first holding device and in particular the lowest position of the holding device or of the stamp, that is to say when preferably the mouth of the container is already located at the base of the container, the fold is preferably pressed against the stop element or an upper stop and is pushed outwards somewhat by a radius on the holding device.

Advantageously, therefore, the holding device is configured in such a way or has such a shape that, during a compression of the container, it causes the fold to turn out or to push outwards relative to a radial direction of the container and preferably also relative to a direction perpendicular to a longitudinal direction of the container.

Due to this “pushing-away” of the fold, removal of the container from the holding device is made easier. Preferably, the fold is also formed in such a way that the containers as a whole can be stacked more easily.

In one preferred embodiment, the stop element is formed circumferentially relative to a longitudinal direction of the holding device and preferably also relative to the longitudinal direction of the container to be compressed. In this way, it is possible to treat the fold along its entire circumferential direction. The stop element may thus be configured as a protrusion which extends at least partially and preferably entirely around the holding device, wherein this protrusion also extends at least in a radial direction of the first holding device, and wherein this radial direction is perpendicular to the infeed direction in which the first holding device is fed towards the second holding device.

In a further advantageous embodiment, the first holding device has a transition section in which a cross-section of the first holding device widens in a continuous manner. Advantageously, this transition section is provided in such a way that it widens in a direction away from the container to be compressed, in the longitudinal direction thereof. This transition section is preferably configured in such a way that it brings about said widening of the fold. This widening is preferably continuous. Preferably, the transition section also has a curved profile in its cross-section. This transition section is preferably adjoined in the direction of the container by a section having a constant cross-section.

Advantageously, a cross-section of the first holding device in said transition section widens by at most 20%, preferably by at most 10%, preferably by at most 5% (based on the section of constant cross-section adjoining said transition section). Advantageously, a cross-section of the first holding device in said transition section widens by at least 0.5%, preferably by at least 1%, preferably by at least 3%, preferably by at least 5% (based on the section of constant cross-section adjoining said transition section).

The longitudinal direction of the container is preferably also an axis of symmetry of the container, which particularly preferably leads from the mouth of the container to the base thereof. Advantageously, the longitudinal direction of the container to be compressed also corresponds to the infeed direction in which the first holding device is fed towards the second holding device. The container is preferably compressed in an upright state.

In a further advantageous embodiment, the stop element may adjoin said transition section or itself be formed by said transition section.

In a further advantageous embodiment, the stop element is arranged above a transition section on the first holding device and said transition section is a curved section and in particular a section curved radially outwards over the circumferential direction or a section which, as mentioned above, widens radially outwards.

In a further advantageous embodiment, the apparatus or the holding device respectively has a tempering device for tempering at least one section of the first holding device. In particular, a region of the abovementioned stop is thus heated. In order that the fold remains in this outwardly oriented position, even after the release or venting of the compressed container, it is proposed here that the holding device is tempered in particular in the region of said stop element. The applicant has been able to ascertain that a tempering in a range between 40° C. and 80° C. is sufficient.

In a further advantageous embodiment, this tempering device serves to temper at least one section of the stop element in order in this way also to heat a surface of the holding device which comes into contact with the fold.

In a further advantageous embodiment, the pressure generating device has a closure element which at least partially closes a mouth of the container to be compressed, in order thus to enable a controlled and/or reduced escape of air from the container during the compression of the latter. For example, a throttle element may be provided which permits only a limited escape of air during the compression, so that a given internal pressure in the container is maintained.

Advantageously, a valve element is arranged in the closure element. This may be, for example, a valve which opens automatically above a given overpressure, in order thus to prevent excessively high pressures from occurring inside the container during the compression of the latter. This application of an overpressure is difficult to understand at first glance since this higher pressure also increases the force necessary for compression. However, the applicant has discovered that this application of pressure also has an effect on the fold and stabilizes the latter against kinks, and moreover an easier removal of the container from the holding device is achieved.

Preferably, the first holding device projects into the container in at least one compression state. Preferably, the holding device (or a region thereof) also has at least one section which, at least at times, projects into an overturned section of the container to be compressed. Advantageously, in at least one compression state, the holding device is completely surrounded in its circumferential direction by two superposed wall sections of the container.

In a further advantageous embodiment, the apparatus has a stripping device and/or removal device for stripping a compressed container from the first holding device. This may be a stripping device which is integrated for example in the first holding device and which pushes the container, via the mouth thereof, out of the holding device. However, it would also be possible that a stripping device is provided outside of the first holding device, which stripping device makes contact with the container at its fold and thus strips said container. The stop element may also simultaneously serve as a stripping element.

The removal device may be configured as a displaceable body and in particular as a body which can be displaced in the infeed direction, which body presses against the mouth or the mouth rim of the container in order to push the latter away from the first holding device.

In a further advantageous embodiment, the apparatus has a carrier on which several holding devices are arranged. In this way, it is preferably possible to compress several containers simultaneously.

In a further advantageous embodiment, the apparatus has a transport device which feeds the plastics material containers to the first holding devices. This transport device may transport the containers in a transport direction which is preferably perpendicular to a movement direction of the first holding device relative to the second holding device.

Embodiments of the invention are also directed to a method for compressing containers. First, plastics material containers are provided and then these plastics material containers are compressed. For this, a first holding device holds a first region of a container to be compressed, and a second holding device holds a second region of the container to be compressed, wherein the second region is at a distance from the first region. Furthermore, a movement device moves the first holding device towards the second holding device in an infeed direction in order to compress the container located between the first holding device and the second holding device. Furthermore, the first holding device with the first region of the container that is held by the first holding device is introduced into a further section of the container, thereby forming a fold running circumferentially relative to a longitudinal direction of the container.

According to embodiments of the invention, at least at times during the compression, the fold in a predefined relative position of the first holding device relative to the second holding device makes contact with a stop element provided on the first holding device and/or a pressure generating device applies to an interior of the container to be compressed, at least at times during the compression of the latter, an internal pressure which is greater than the external pressure prevailing around the container. Advantageously, this is an overpressure of at least 0.5 bar.

As mentioned above, these two procedures serve to prevent or to reduce stress whitening in the material. Advantageously, both measures will be used cumulatively, that is to say both the application of pressure and the contacting of the fold by the stop element take place.

In a further advantageous method, the container, prior to being compressed, is preloaded with a predefined pressure which is greater than the ambient pressure. Advantageously, a pressure will be provided here which is at least 0.5 bar above the atmospheric pressure.

### BRIEF DESCRIPTION

Some of the embodiments will be described in detail, with reference to the following figures, wherein like designations denote like members, wherein:

FIG. 1 shows a schematic diagram to illustrate a method;

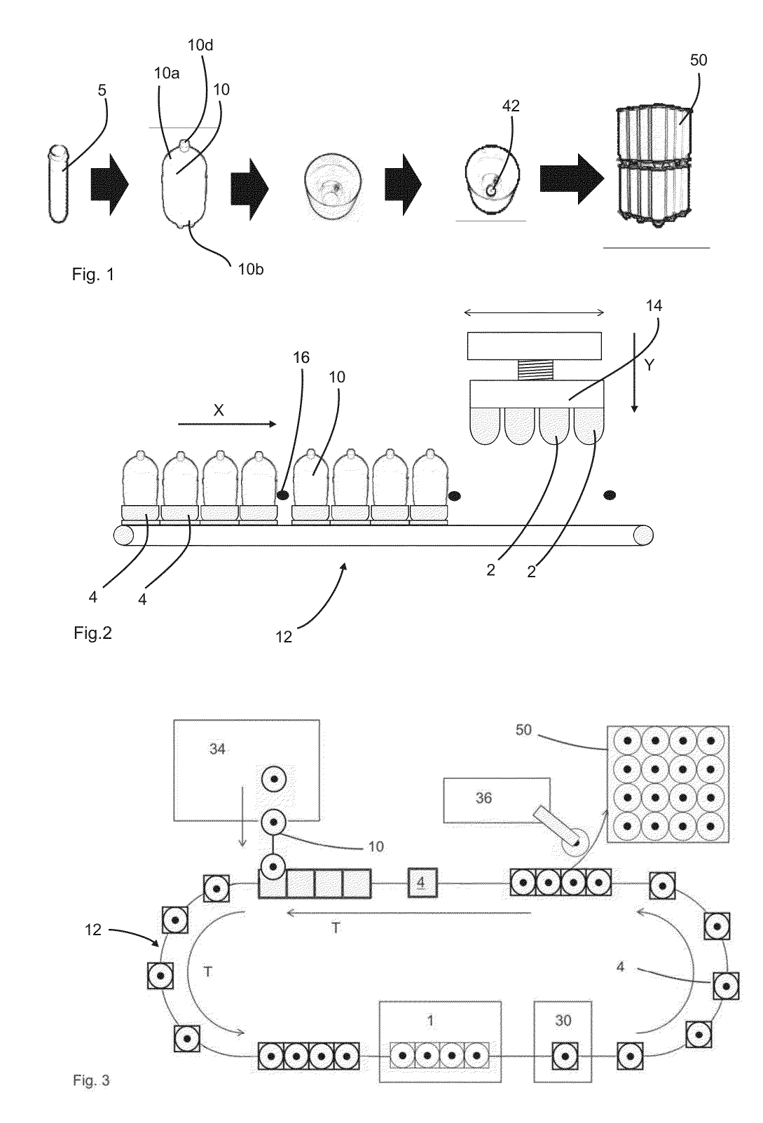

FIG. 2 shows an apparatus for compressing containers in a first embodiment;

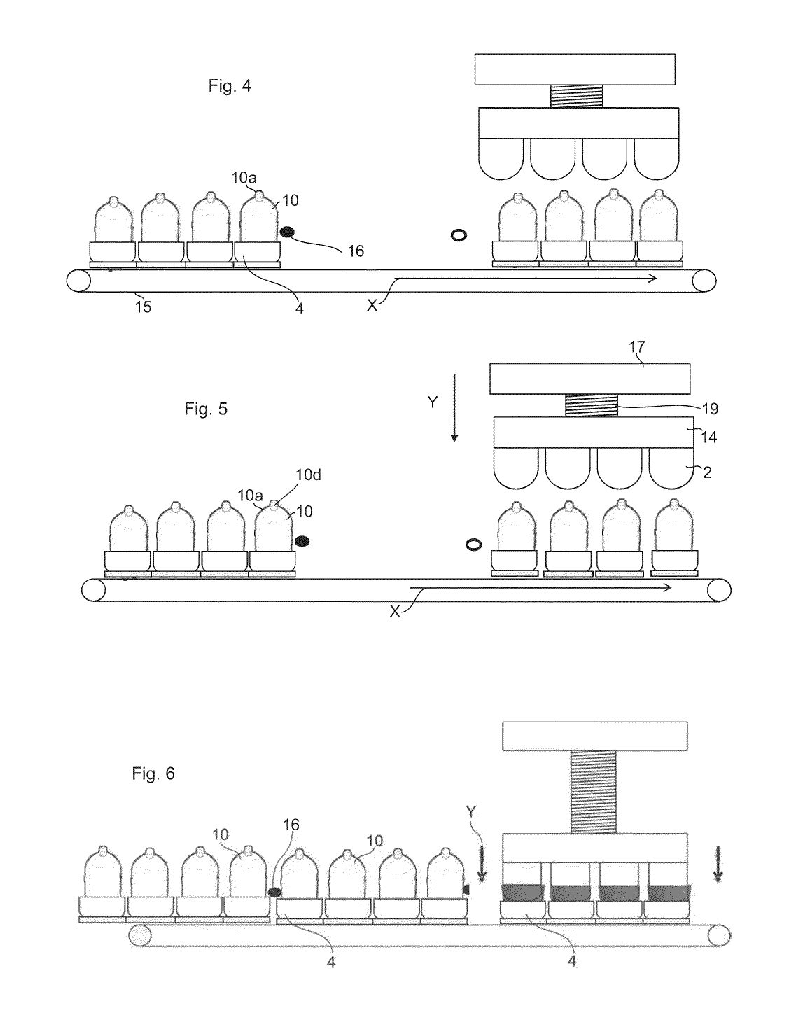

FIG. 3 shows a plan view of an apparatus;

FIG. 4 shows a diagram of an apparatus in a further method stage;

FIG. 5 shows a diagram of the apparatus in a further method stage;

FIG. 6 shows a diagram of the apparatus in a further method stage;

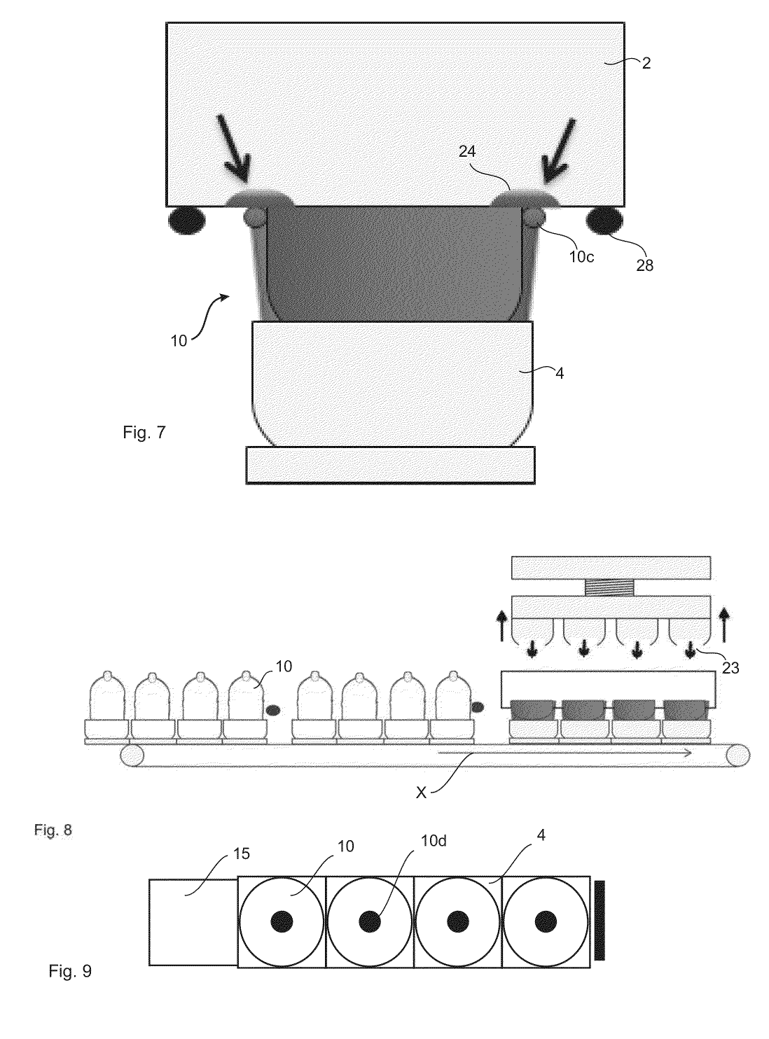

FIG. 7 shows a detail view to illustrate a compression of the container;

FIG. 8 shows a further diagram of the apparatus in a further method stage;

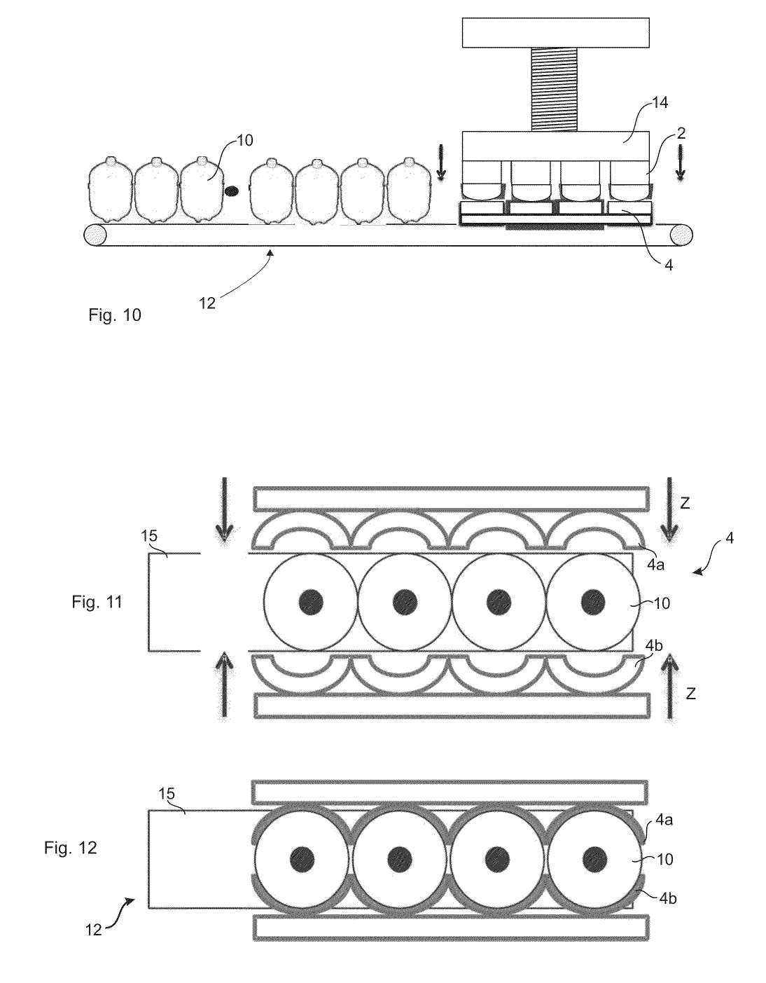

FIG. 9 shows a diagram of holding devices with containers;

FIG. 10 shows a further diagram of a method;

FIG. 11 shows a diagram of an apparatus with a further advantageous arrangement of the second holding devices;

FIG. 12 shows the diagram of FIG. 11 with the holding devices closed;

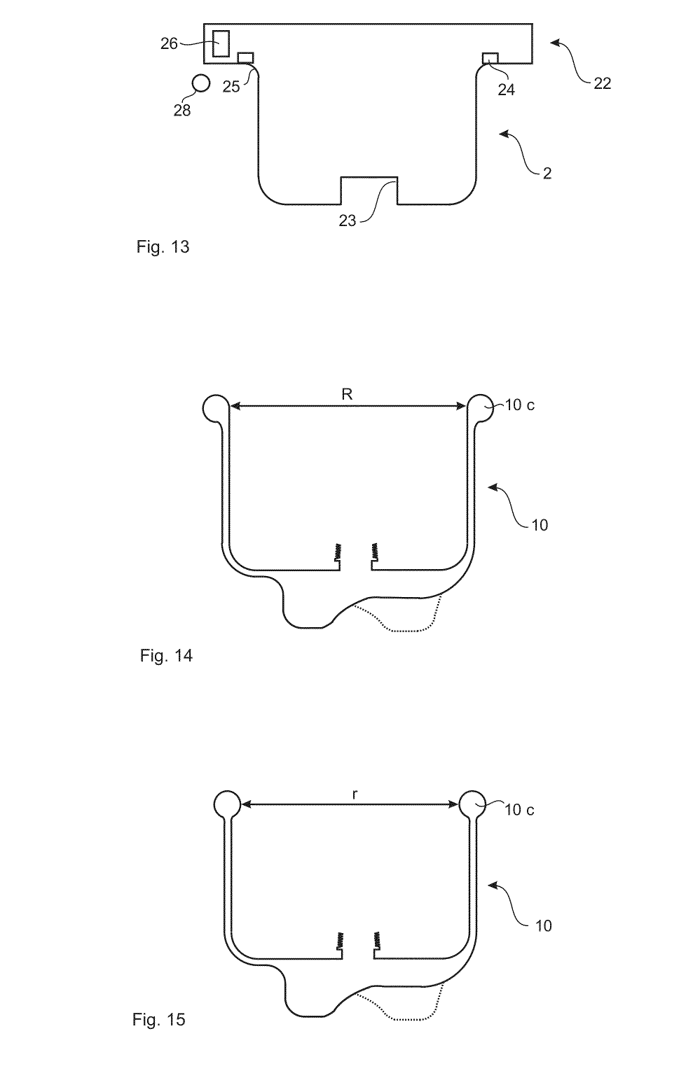

FIG. 13 shows a further diagram to illustrate the compression of a container;

FIG. 14 shows a further diagram to illustrate the compression of a container;

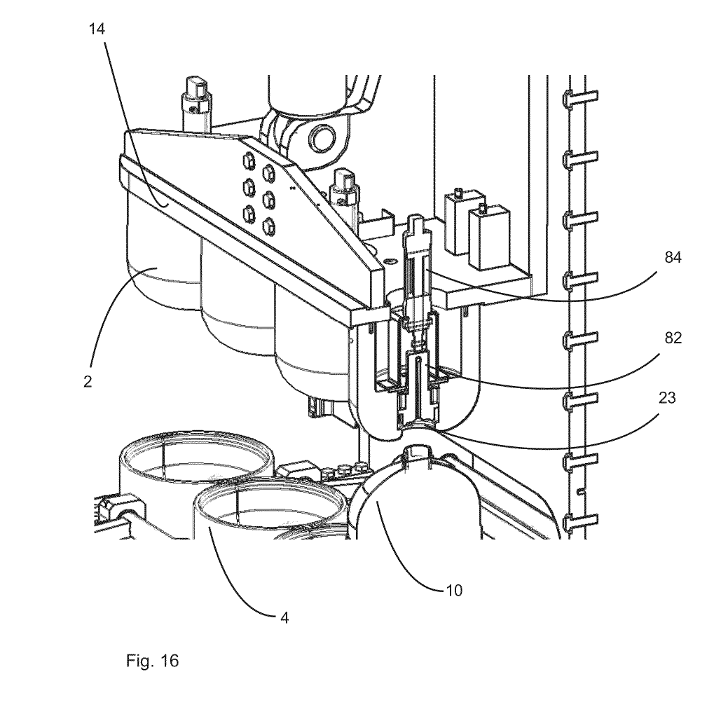

FIG. 15 shows a further diagram to illustrate the compression of a container; and

FIG. 16 shows a diagram of an apparatus.

### DETAILED DESCRIPTION

FIG. 1 shows a diagram of the method for producing the compressed containers. The method proceeds initially from a plastics material preform 5 which is transformed by means of a transforming device, such as for example a stretch blow moulding machine, to form the container 10. In a further method step, this transformed container is compressed, in particular by the apparatus according to embodiments of the invention, in such a way that a mouth region of the plastics material container is pushed into a base region of the plastics material container. Reference 10a denotes a first region of the container to be compressed, which is a region that also contains the mouth of the container. Reference 10b denotes a second region of the container to be compressed, which here is a base region.

In a further method step, a cap or a closure 42 is placed onto the mouth. A large number of such compressed containers are then brought together to form a pallet 50.

FIG. 2 shows a diagram of an apparatus according to embodiments of the invention for compressing the containers. Here, four first holding devices 2 are provided which, in order to compress the containers, interact with the mouth region of the containers and press or compress the latter in the direction of the second holding devices 4.

In the embodiment shown here, four such first holding devices 2 are arranged on a common carrier 14 and can thus be fed downwards here in the infeed direction Y onto the containers 10.

Reference 12 denotes in its entirety a transport device which serves here for transporting the containers. More specifically, this transport device feeds the non-compressed containers to the first holding devices 2 and thereafter also preferably transports the compressed containers away from the compressing device. Reference 16 denotes a position determining unit, such as for example a light barrier, by which the position of the containers along the transport direction X can be determined. It would be conceivable that the transport device itself is controlled as a function of a signal of this positioning unit. However, it would also be possible that the movements of the individual second holding devices 4 can be controlled independently of one another and preferably also these control operations take place as a function of the position determining unit.

In addition, barrier elements may also be provided which at least at times prevent any further transport of the second holding devices 4 along the transport direction X.

In the starting situation shown in FIG. 2 (the following description nevertheless refers also to further figures), all the first holding devices 2 or all the stamps are in a top position. In the method, it is advantageously queried whether the holding devices are actually in a top position. Furthermore, at this point in time, preferably a stop (not shown) on the holding devices is preheated, in particular to a temperature in a range between 50° C. and 80° C., preferably between 55° C. and 75° C., preferably between 60° C. and 65° C. In this case, this temperature is preferably queried and adjusted by means of a controller. The purpose of this temperature control will be explained in more detail below.

In the embodiment shown in FIG. 2, here four containers stand in a single carrier on a transport belt. At the controller side, once again it can be queried whether in fact all of the four containers are present. If this is not yet the case, a container barrier can be closed so as to avoid the situation whereby less than a predefined number of containers, here less than four containers, pass to the first holding devices.

FIG. 3 shows a further diagram of an apparatus according to embodiments of the invention. Here, too, the transport device 12 is again provided, which here transports the individual second holding devices 4 along a circumferential transport path T. Here, this transport path contains straight sections and curved sections. However, the transport path preferably runs in one plane. As shown in the figure, the plastics material containers 10 are first produced in a transforming device 34 and then inserted into the respective second holding devices 4.

The individual holding devices 4 are then grouped into groups of four and enter the apparatus 1 according to embodiments of the invention, in which the compression of the plastics material containers takes place. In the embodiment shown in FIG. 3, the movement of each individual holding device 4 is independent of the movements of further holding devices 4. In this way, different groups can selectively be created, but also the groups of holding devices can be broken up again.

Located downstream of the apparatus 1 in the transport direction of the containers is an inspection device 30 which examines the individual plastics material containers produced. In this region, a separation of the individual holding devices 4 may already take place. The holding devices 4 with the compressed containers 10 located therein are then fed to a palletizing device 36 which forms pallets 50 of compressed plastics material containers. A closing device (not shown) may be located between the apparatus 1 and the palletizing device, which closing device applies closures to the mouths of the compressed containers 10.

In the method presented here and in the introduction above, four containers in one carrier are moved below the first holding devices at a maximum speed. The separation is in this case predefined in particular by the size of the individual carriers or the second holding devices 4. The holding devices 4 may themselves be attached to the transport device 12 (or arranged in a movable manner) via carrier elements. In a further step, it is queried whether the four containers are actually present.

The transport device may also have acceleration and delay regions, which accelerate or delay the transport movement of the individual holding devices. Alternatively, however, the transport device may also be a transport belt on which the individual holding devices are arranged. The use of transport chains or rotatable transport devices would also be conceivable.

The four stamps or the first holding devices 2 travel further to just before the mouth of the individual containers. The position and speed of the individual first holding devices may again also be queried. Advantageously, the first holding devices are advanced towards the plastics material containers at a speed of between 100 mm/sec and 500 mm/sec, preferably between 200 mm/sec and 400 mm/sec, and particularly preferably of approximately 300 mm/sec.

The individual stamps or holding devices 2 are then moved slowly downwards and thus compress the containers. In doing so, the containers are preferably first centred. Advantageously, the individual holding devices each have centring elements such as so-called centring bells. Advantageously, the individual first holding devices also have sealing devices or elements which limit an air flow through the mouths during the compression.

Advantageously, a position of the first holding devices 2 in the infeed direction Y is again queried via a detection device.

Furthermore, the containers are preloaded with a predefined pressure, for example with 0.5 bar above the atmospheric pressure. Advantageously, pressure measuring devices are also provided, which determine the internal pressure in the containers during the compression operation. Control devices may also be provided, which control the internal pressure in the container.

The holding devices then accelerate downwards and in this way the containers are rolled inwards. In doing so, an internal pressure builds up in the containers. Certain parameters, such as a position of the holding devices, a pressing force and also the speed may once again be checked during this. Advantageously, a compression force lies in a range from 50 kN to 100 kN, preferably between 60 kN and 80 kN, and preferably at around 70 kN (calculated here for four holding devices). The speed at which the advancing and the compression of the plastics material containers takes place is preferably between 50 mm/sec and 200 mm/sec, preferably between 70 mm/sec and 130 mm/sec.

Advantageously, a valve device is further provided, which opens above a given overpressure in the interior of the container, so that the maximum pressure in the interior of the container is not exceeded. Advantageously, this maximum pressure is between 2 bar and 3 bar and preferably is 2.5 bar. Preferably, a mechanical and/or electrical control of the internal pressure in the container may take place here. A defined nozzle or aperture may be provided for example, but also a pressure control valve.

During the compression, preferably a circumferential rolling fold occurs on the container. At the lowest position of the first holding device, said fold preferably presses against a radius of the first holding device and preferably rolls outwards by a few millimetres. Preferably, the end position of the holding devices is again also queried, which may take place for example via a limit switch or also via the detection of a position of the holding devices.

Preferably, the first holding devices are briefly held in this position in order, as will be described in more detail below, to temper the rolling fold at said groove.

In a further method step, the holding devices move upwards again, preferably at relatively high speed. It is conceivable that the centring bell or a further element pushes the rolled container downwards. The speed of this return movement is advantageously again between 200 mm/sec and 400 mm/sec, and advantageously is approximately 300 mm/sec.

The containers, which are now compressed or rolled inwards, remain in the second holding device or the base cup. In these holding devices, the containers that have thus been rolled inwards are transported away and at the same time further four containers can be transported to the first holding devices 2. Here, too, it may also again be queried whether the four containers that have already been compressed have been moved out. By way of example, a double light barrier may be provided for this purpose.

The containers which have been rolled inwards are removed from their holding devices, preferably provided with a dust cap and palletized. The empty second holding devices move back to the blow moulding machine in order to receive the next containers.

FIG. 4 shows a further diagram of an apparatus according to embodiments of the invention. Here, the four containers 10 move below the stamps or the first holding devices at a maximum speed. For this purpose, the transport belt 15 may again have an acceleration or delay ramp. However, it can be seen that in FIG. 4 the position of the individual containers has not yet been precisely aligned. For this purpose, an exact positioning may be carried out for example by a suitable movement of the transport device, but also by an individual movement of the individual holding devices 4. However, the second holding devices may also be constructed or configured in such a way that, due to their size, they already have the correct separation of the containers below the press or below the first holding devices.

In the situation shown in FIG. 5, the containers 10 or the mouth regions 10a thereof with the mouths 10d are aligned exactly below the holding devices. Reference 17 schematically denotes a drive device which brings about the advancing movement of the first holding devices 2. This drive device 17 may have for example one or more drive spindles 19. In addition, however, it would also be possible that a linear motor drive or a pneumatic drive or a hydraulic drive is used as the drive. With particular preference, use will be made of a hydraulic drive which is characterized in particular by its small size and the possibility for maintenance.

In the situation shown in FIG. 6, the first holding devices 2 have now been advanced towards the second holding devices 4 and in this way the plastics material containers located therebetween have been compressed. It can be seen that here already two further groups of containers may stand ready, which are to be compressed subsequently.

FIG. 7 shows a detailed diagram of a rolling process. Here, the first holding device 2 is again shown, which is advanced towards the second holding device 4. The first holding device has a circumferential groove 24 which, during the compression of the container, makes contact with a rolling fold 10c. Due to this contacting with the rolling fold 10c, the rolling operation as a whole can be improved and in particular it is possible to prevent the occurrence of stress whitening in the container. Advantageously, this circumferential stop is tempered, as mentioned above. In addition, the first holding device preferably also has a widening, that is to say a section in which a cross-section of the holding device widens from the bottom upwards. This section (not shown in FIG. 7) likewise serves to act on the rolling fold 10c. In addition, position detection means 28 may be provided, which detect a position of the rolling fold 10c and/or a relative position between the holding devices 2, 4.

Furthermore, it would also be possible to reuse and thus recycle the compressed air, which is pushed out of the container during the compression, to preload the subsequent containers. It is also conceivable that exhaust air from the upstream blow moulding machine can be used to apply a pressure to the containers. The advantage could lie in the fact that for example cleaned air or sterile air from the blow moulding machine can also be used for preloading purposes. The generated compressed air can also be used for pneumatic drives.

FIG. 8 shows a further diagram of the apparatus according to embodiments of the invention, wherein, here also, centring elements 23 are shown which, when they are fed towards the plastics material containers 10, centre the latter. These may be, for example, so-called centring bells which align a mouth section of the containers.

FIG. 9 correspondingly shows an arrangement of four second holding devices 4 with plastics material containers 10 arranged therein. Reference 15 denotes a transport means such as a transport belt or a transport carrier. Reference 10d denotes a mouth section of the containers 10.

In the diagram shown in FIG. 10, the holding devices 2, as mentioned above, have been fed towards the holding devices 4 and the containers are thus fully compressed. It is advantageous if, during the compression, no sharp-edged folds exhibiting so-called stress whitening are created, since the containers otherwise have unattractive creases after decompression and filling and areas of weakening are also obtained at these creases, and thus the containers no longer have the requisite pressure stability and thus cannot be used for example for carbonated beverages. However, in order to ensure that the containers are well compressed and not merely scrunched up by the stamp, it is proposed here that the containers are preloaded with a slight pressure for example through a valve in the stamp, which seals off the mouth. The holding device 2 then compresses the container and, due to the reduction in volume, the pressure in the container rises further. It is pointed out here that the internal pressure in the container also cannot be allowed to rise at will, since otherwise the pressure force would rise to an extreme extent and the container ultimately might burst. The air is therefore also released out of the container in a controlled manner above a given pressure, so as to maintain a given pressure in the container. As mentioned above, the applicant has discovered that the rolling operation can pleasantly take place at a pressure in the range from 2 to 2.9 bar and preferably at approximately 2.2 bar (overpressure) or more.

For the pressure control, use may be made of an electronic pressure control valve which, once a predefined pressure is reached within the container, opens so far that the pressure under no circumstances becomes higher. This is once again advantageous since the necessary force for compressing the containers is directly dependent on the pressure in the container. At an internal pressure of 2.5 bar, the force on the holding devices or each individual holding device is already approximately 15.3 kN, which corresponds to a weight force of approximately 1.53 t. If, on the other hand, the pressure is too low, uncontrolled folds with stress whitening may form on the container.

It would also be conceivable to release the pressure from the container, for example via a mechanical throttle, such as a perforated aperture. In this case, however, a substantially constant volume flow would be necessary. By way of example, at a volume flow of 4 l/sec into the container through an aperture having a diameter of 4.6 mm, a dynamic pressure in the region of 2.5 bar builds up, which would lead to the same result.

The advantages of embodiments of the invention lie in the fact that the compressed containers can in this way readily be stacked, in addition can also be transported inexpensively and thereby retain their properties. The containers once unrolled again still have the same barrier properties and the same pressure stability as before being rolled, provided that no sharp-edged folds with stress whitening occur in the PET material.

FIGS. 10 to 12 show a further embodiment of the apparatus according to embodiments of the invention. Here, too, the containers 10 are brought to the first holding devices 2 via a transport device 12. However, while in the preceding embodiments the containers were already located in the second holding devices 4, now these second holding devices are arranged in a stationary manner below the first transport devices 2 in or relative to the transport direction of the containers. In this case, the containers are likewise brought into the intended position for compressing and then the second holding devices 4 are closed.

FIG. 11 illustrates this operation. It can be seen that the second holding devices 4 are of two-part construction here and comprise a part 4a and a part 4b. As soon as the containers 10 are in the correct position, these parts 4a, 4b are fed towards one another in the direction Z, resulting in the state shown in FIG. 12. The containers are then compressed by the first holding devices 2 (not shown) coming from above in FIGS. 11 and 12.

This embodiment has an advantage that the second holding devices 4 are always correctly positioned relative to the first holding devices 2 in the transport direction X of the containers 10. However, the second holding devices must in this case be of two-part and preferably half-shell-like design.

FIG. 13 illustrates the compression of the container and in particular the effect on the rolling fold 10c. This rolling fold 10c is shown in FIG. 14. It can be seen that the first holding device 2 has a circumferential protrusion 22. During the compression of the container 10, this circumferential protrusion or radius presses against the rolling fold 10c and the latter rolls outwards by a few millimetres. Reference 25 denotes a transition region of the first holding device 2. In this transition region 25, a cross-section of the first holding device 2 widens from the bottom upwards. This is preferably a continuous widening. Preferably, the holding device has a circular cross-section (perpendicular to the infeed direction) at least in the transition section. It can also be seen that this transition region is curved. Reference 24 denotes a heating device which heats the stop and/or also the transition region 25. Reference 26 denotes in a highly schematic manner a pressure application device which, by applying compressed air, can encourage a detachment of the container from the first holding device.

By means of position querying devices 28, once again the end position can be queried and advantageously also the position of the rolling fold 10c can be checked. Reference 23 denotes a centring section which serves for centring the container and which can receive the mouth region of the container and/or a thread of the container.

FIG. 14 shows a diagram of a rolled container. Here, a tempering is used, that is to say the transition region 25 has been heated by means of the heating device 24. It can be seen that the rolling fold 10c is pressed outwards here, thus forming the radius R. In this way, it is possible to stack the compressed containers inside one another and also to separate them again from one another.

FIG. 15 shows a diagram in which no tempering has been used. It can be seen that here the radius r is smaller than the radius R shown in FIG. 14, and the rolling fold 10c protrudes further inwards. These rolling folds bear tightly against the next container during the stacking and are more difficult to separate from one another.

Finally, FIG. 16 shows a diagram of an apparatus according to embodiments of the invention. Here, the second holding devices 4 are again shown, it being unimportant here whether these are moved with the transport device or are already located below the first holding devices 2. Also shown is one of the first holding devices 2 together with the inner workings thereof. It is possible to see here a plunger element 82 which is movable here in a vertical direction, that is to say the direction Y, in which also the first holding devices 2 are fed towards the containers 10. In order to detach the containers 10 from the first holding devices 2, this plunger element 82 can be pushed downwards and thus can push away the compressed container. Reference 84 denotes a drive device, such as for example a hydraulic and preferably pneumatic drive device, which initiates the movement of this plunger element 82.

However, this plunger element 82 can also be used during the compression, in order to partially seal off the mouth 10a of the container so that only a defined quantity of air can escape from the container during the compression. However, it would also be possible to use different elements on the one hand for pushing away the containers and on the other hand for sealing off the containers.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCES

1 apparatus
2 first holding devices
4 second holding devices
4a, 4b parts
5 plastics material preform
10 containers
10a mouth regions
10b base regions
10c rolling fold
10d mouths
12 transport device
14 carrier
15 transport belt
16 position determining unit
17 drive device
19 drive spindle
22 protrusion
23 centring section
24 heating device
25 transition region
26 pressure application device
28 position querying devices
30 inspection device
34 transforming device
36 palletizing device
42 closure, cap
50 pallet
82 plunger element
84 drive device
Y infeed direction
X transport direction
T transport path
Z direction
R radius
r radius

1. An apparatus for compressing plastics material containers, comprising: a first holding device which is suitable for holding a first region of a container to be emptied, having a second holding device which is suitable for holding and/or supporting a second region of the container to be emptied, wherein the second region is at a distance from the first region, having a movement device which is suitable for moving the first holding device towards the second holding device in order to compress the container located between the first holding device and the second holding device, wherein the first holding device has a cross-section which is preferably smaller than a cross-section of the container to be compressed, so that the first holding device with the first region of the container that is held by the first holding device can be introduced into a further section of the container, thereby forming a fold running circumferentially relative to a longitudinal direction of the container, wherein there is provided on the first holding device a stop element which makes contact with the fold in a predefined relative position of the first holding device relative to the second holding device and/or the apparatus has a pressure generating device which applies to an interior of the container to be compressed, at least at times during the compression of the latter, an internal pressure which is greater than the external pressure prevailing around the container.

2. The apparatus according to claim 1, wherein the stop element is formed circumferentially relative to the longitudinal direction.

3. The apparatus according to claim 1, wherein the first holding device has a transition section in which a cross-section of the first holding device widens in a continuous manner.

4. The apparatus according to claim 1, wherein the stop element is arranged above a transition section on the first holding device and said transition section is a curved section.

5. The apparatus according to claim 1, wherein the first holding device has a tempering device for tempering at least one section of the first holding device.

6. The apparatus according to claim 5, wherein the tempering device serves for tempering at least one section of the stop element.

7. The apparatus according to claim 1, wherein the apparatus has a closure element which at least partially closes a mouth of the container to be compressed, in order thus to enable a controlled escape of air from the container during the compression of the latter.

8. The apparatus according to claim 7, further comprising a valve element or a throttle element is arranged in the closure element.

9. The apparatus according to claim 1, wherein the apparatus also has a stripping device for stripping a compressed container from the first holding device.

10. The apparatus according to claim 1, wherein the apparatus has a carrier on which several first holding devices are arranged.

11. The apparatus according to claim 1, wherein the apparatus has a transport device which feeds the plastics material containers to the first holding devices.

12. A method for compressing containers, comprising the steps:
providing plastics material containers;
compressing the plastics material containers, wherein a first holding device holds a first region of a container to be compressed, and a second holding device holds a second region of the container to be compressed, wherein the second region is at a distance from the first region, and a movement device moves the first holding device towards the second holding device in an infeed direction in order to compress the container located between the first holding device and the second holding device, wherein the first holding device with the first region of the container that is held by the first holding device is introduced into a further section of the container, thereby forming a fold running circumferentially relative to a longitudinal direction of the container, wherein, at least at times during the compression, the fold in a predefined relative position of the first holding device relative to the second holding device makes contact with a stop element provided on the first holding device and/or a pressure generating device applies to an interior of the container to be compressed, at least at times during the compression of the latter, an internal pressure which is greater than the external pressure prevailing around the container.

13. The method according to claim 12, wherein the container, prior to being compressed, is preloaded with a predefined pressure which is greater than the ambient pressure.
